(19) United States
(12) Patent Application Publication
(10) Pub. No.: US 2016/0151747 A1
(43) Pub. Date: Jun. 2, 2016

(54) Porous Nanomembranes

(71) Applicants: ACIB GMBH, Graz (AT); UNIVERSITÄT FÜR BODENKULTUR WIEN, Vienna (AT)

(72) Inventors: Alois Jungbauer, Wien (AT); Agnes Rodler, Wien (AT); Gerhard Sekot, Wien (AT); Rupert Tscheliessnig, Wien (AT)

(73) Assignees: ACIB GMBH, Graz (AT); UNIVERSITAT FUR BODENKULTUR WIEN, VIENNA (AT)

(21) Appl. No.: 14/900,436

(22) PCT Filed: Jun. 10, 2014
(86) PCT No.: PCT/EP14/62130

§ 371 Date: Dec. 21, 2015

(30) Foreign Application Priority Data
Jun. 25, 2013 (EP) 13173576.3

(51) Int. Cl. B01D 69/12; B01D 69/02; B01D 67/00; B01D 61/02

(52) U.S. Cl. CPC B01D 69/125; B01D 61/027; B01D 69/02; B01D 67/0032; B01D 2323/02; B01D 2323/18; B01D 2323/24; B01D 2325/02

(57) ABSTRACT

The invention relates to an isolated waterproof polymeric nanomembrane comprising pores of different geometric shapes and of a controlled size between 10 and 1000 nm, which is larger than the thickness of the membrane, and a method of producing the same comprising the process steps a. Providing a sacrifice layer on a surface of a solid support; b. Providing a polymerized layer of less than 1000 nm thickness on the surface of the sacrifice layer, by depositing a mixture of a polymer or a polymer precursor with a geometrically undefined pore template which is larger than the thickness of the polymerized layer, optionally followed by polymerization and/or crosslinking; c. Removing the pore template to obtain the polymerized layer with a controlled pore size; and d. Removing the sacrifice layer, thereby separating the solid support from the polymerized layer.

### FIELD OF THE INVENTION

The invention refers to porous nanomembranes with a controlled pore size, methods of manufacturing such nanomembranes and specific applications.

### BACKGROUND ART

Nanomembranes are very attractive for a variety of applications including separation technologies, biomedical applications, biocatalysis, chemical synthesis, bioenergy, and energy. A wide variety of synthetic membranes is known. They can be produced from organic materials such as polymers and liquids, as well as inorganic materials. The most of commercially utilized synthetic membranes in separation industry are made of polymeric structures. Numerous membranes have already been described, though there is a need for enabling technologies to produce them in large scale. The large scale production is the basis for a breakthrough of this technology and industrial application.

EP2017055B1 describes a method for production of a polymer thin film comprising: providing a sacrifice layer on a surface of a support, providing a layer of thermally-cross linkable resin composition on a surface of the sacrifice layer, cross-linking a thermoplastic resin in the layer of thermally-cross linkable resin composition thus provided, and after the thermoplastic resin is cross-linked, separating the support by removing the sacrifice layer. The polymer thin film would have a self-supporting property even if the film thickness is 100 nm or less.

A large, freestanding 20 nm thick nanomembrane based on an epoxy resin is described by Watanabe et al. (2007) Adv. Mater. 19: 909-912. The tensile strength of the membrane was 30 MPa.

Li et al. (2010) Macromol. Chem. Phys. 211: 863-868 describe an ultra-thin free-standing proton-conducting membrane with organic/inorganic sandwich structure. A proton-conducting membrane of (PEI/PCGF)/SiO₂/(PEI/PCGF) with a sandwich structure was prepared. Membranes with areas up to about 16 cm² and thicknesses of 600 nm have been obtained.

Microstructured membranes have a variety of applications, including bioseparation, bioanalytical and bioreactor applications. Therefore, some porous membranes have been provided.

WO2012/097967 A1 describes porous polymer membranes having a pore size of 5-400 nm, manufactured by dispersing a metal salt nanoparticle in a polymer solution, coating a substrate with the dispersion, and removing said metal salt particles by dissolution. Whereas the membrane has a thickness between 50 nm and 40 μm, the nanoparticle size determining the pore size of the membrane is ranging between 15 to 40 nm.

The same method is applied by Kellenberger et al. (J. Membr. Sci 2012, 387-388, 76) who describe membranes having a thickness of about 2-3 μm and an average pore diameter of 39 nm and 18 nm, respectively.

Perforated layer-by-layer membranes are produced according to a different approach. Zimnitsky et al. (Langmuir 2008, 24, 5996-6006) describe membranes based on polyelectrolyte layers that are made porous by wetting. Likewise, the membranes made of polyelectrolyte layers described by Orlov et al (Macromolecules 2007, 40, 2086-2091) are treated with water vapor to form the porous structure.

Fujikawa et al. (Langmuir (2009) 25(19): 11563-11568) describe a freestanding ultrathin titanic membrane with nanochannel design produced by molecular imprinting. A poly(vinyl alcohol) (PVA)/titania (TiO₂) composite was prepared by spin coating. The thickness of the film was adjusted to 30-50 nm. A template molecule (4-phenylazo)benzoic acid was introduced into the film and was removed after film formation. Thereby a channel was formed across the film, which diameter is determined by the small organic molecule of a few nanometer size.

Xue et al. (Advanced Materials Research (2012) 538-541: 120-123) describe a porous polystyrene film obtained by a template-leaching technique using starch particles as a template. The starch particles would provide for pores of at least 15 μm size, and are preferably used for thick films.

Xu and Goedel (Chem Int Ed Engl. 2003 Oct. 6; 42(12):5996-6006) describe a thin free-standing nanomembrane bearing a high density of uniform pores.

For specific applications it would be desirable to provide nanomembranes with a high porosity. However, there is a risk that such membranes get instable showing a poor tensile strength, thereby losing the properties of a self-supporting membrane.

### SUMMARY OF INVENTION

It is the objective of the present invention to provide improved nanomembranes with a high degree of porosity, while maintaining their stability.

The objective is solved by the claimed subject matter.

According to the invention, there is provided an isolated, waterproof polymeric nanomembrane comprising pores of different geometric shapes and of a controlled size between 10 and 1000 nm, which is larger than the thickness of the membrane.

Specifically, the nanomembrane of the invention is based on a polymeric homogeneous matrix, or which comprises a polymer, which polymer is comprised in a homogeneous matrix. The homogeneous matrix is composed of only one polymer or a homogeneous mixture of one or more polymers, thereby providing for a high tensile strength. Such matrix may e.g. be prepared by mixing liquid components of the matrix and further solidifying said matrix, such as by cross-linking the components.

Preferably the matrix is provided as a single layer, or only one layer of a homogeneous mixture of the matrix components. Thereby, the use of a series of layers that adhere to each other is preferably avoided.

The waterproof nanomembrane of the invention is specifically useful for use in aqueous media, such as used in biological systems.

According to a specific aspect, the nanomembrane of the invention is stable in aqueous media, e.g. in aqueous solutions at a pH ranging between pH 5 and 9, preferably within pH 5-8, or pH 6-8, or stable in the presence of aqueous media comprising solutes that are weak electrolytes, e.g. in the presence of electrolytes equivalent to 200-300 mM sodium chloride. Therefore, such stable nanomembrane substantially maintains the thickness, porosity and/or density of the matrix in the predefined range, even in the presence of an aqueous media over a prolonged period of time, e.g. during bioseparation, bioreaction, biotransportation and/or biodelivery processes.

Specifically, the nanomembrane of the invention or its matrix comprises less than 80% polyelectrolytes, preferably less than 70%, more preferred less than 60%. The matrix may or may not contain polyelectrolytes, however, specifically not consist of such polyelectrolytes, thereby excluding a matrix that is composed of a series of layers of polyelectrolytes of different polarity that adhere to each other by electrostatic interactions.

The nanomembrane of the invention specifically has a thickness of at least 5 nm and less than 1000 nm, and is preferably 10-500 nm thick, preferably 50-200 or 50-150 nm. Specifically, the surface of the membrane is substantially planar or flat with a preferred tolerance of ±50 nm, preferably ±25 nm.

The membrane preferably is based on a matrix that is substantially planar or flat with a thickness of at least 5 nm and less than 1000 nm, and is preferably 10-500 nm thick, preferably 50-200 or 50-150 nm, and with a preferred tolerance of ±50 nm, preferably ±25 nm. Additionally, the matrix may comprise elevations due to the inclusion of defined voids and/or bodies, e.g. for the purpose of bioseparation, bioreaction, biotransportation and/or biodelivery. For example, the inclusion of ligands provide for additional functions, e.g. by ligand binding interaction, ligand reaction, ligand capturing, or transporter function. For example, inclusions or inclusion bodies such as spherical structures may be included protruding e.g. 100 nm-1000 nm from the membrane surface. The inclusion of voids may provide for additional functions, e.g. by size exclusion.

The pores are specifically aligned in a substantially straight path from the top surface of the membrane to the bottom surface of the membrane, e.g. by cylindrical pores, spherical cavities and/or interconnected pores, which are connected to the exterior of the porous nanomembrane by openings on the surface of the nanomembrane. Thus, the nanomembrane preferably comprises pores having through-thickness porosity.

The porous nanomembrane of the invention specifically provides for the transport of compounds, such as ions, molecules and particles across the nanomembrane.

The pore size is specifically controlled, defining substantially uniform sized pores. The substantially uniform sized pores specifically have an average nominal diameter ranging from 10 nm to 1000 nm, preferably at least 20 nm, 30 nm, 40 nm or 50 nm, up to 500 nm, preferably up to 200 nm or up to 150 nm, with a typical tolerance of ±50%, preferably ±40%, or ±30%, or ±20%. The pore size distribution can be clearly pictured with transmission electron microscopy analysis, as described in example 2. Alternatively pressure drop measurements as well as cut-off experiments with respectively sized molecules may be performed. To measure the relation between thickness of the membrane and average pore size, the respective membrane thickness can be easily derived by scratching experiments with atomic force microscopy analysis (as shown in example 1).

It is specifically preferred that the porosity is less than 1×10⁷ pores/cm², preferably less than 1×10⁶ pores/cm². The specifically preferred areal porosity ranges between 1 and 30%.

It is preferred that the nanomembrane of the invention is self-supporting with an aspect ratio of greater than 10⁴, or greater than 10⁵, or greater than 10⁶, or greater than 10⁷. The lower aspect ratios of e.g. less than 10⁵, are preferably selected if a smaller area or section of a nanomembrane is used, e.g. for analytical use, such as for use in biosensors or lab-on-a-chip devices, where a size in the micrometer, millimeter or centimeter range is preferred. The higher aspect ratios of e.g. at least than 10⁵, are preferably selected for larger scale use, e.g. for analytical, preparatory or industrial use, such as for use in fermenters.

Specifically, the nanomembranes may be produced on a large scale, e.g. to produce such nanomembranes of the invention that extend to an area of 1 cm² to 250 cm², preferably 5 cm² to 25 cm² depending on the intended use of such membrane.

According to a specific aspect of the invention, the nanomembrane may be part of a composite membrane or device, e.g. as a cover to a solid support. Therefore, the nanomembrane of the invention is specifically first provided as an isolated porous nanomembrane that is then layered onto another layer or solid support to obtain the composite membrane.

Specifically, the nanomembrane of the invention has a tensile strength of at least 0.01 MPa, preferably at least 0.1 MPa, or even at least 1 MPa. According to a specific embodiment, the nanomembrane of the invention comprises a thermoplastic resin and/or a thermo-crosslinkable resin.

A specific matrix comprises one or more biocompatible hydrophobic polymers, and/or one or more biocompatible hydrophilic polymers.

A preferred matrix comprises one or more biocompatible hydrophobic polymers, preferably of at least one monomer or oligomer selected from the group consisting of epoxides, acrylates, methacrylates, isocyanates, isothiocyanate, carbonyl chlorides, sulfonyl chlorides, amine, alcohol, phenol, anhydride, thiol, and combinations of any of the foregoing. Preferred examples include epoxide, (epoxy)-precursor, PEI (Polyethyleneimine) and PCGF ([Poly[(o-cresyl glycidyl ether)-co-formaldehyde]].

A further preferred matrix comprises a biocompatible hydrophilic polymer, preferably selected from the group consisting of polyacrylamide, polymethylmethacrylate, polyamide, polyether, polyester, polysulfone, polyethersulfones, sulfonated polyethersulfones, polyvinylalcohol, poly(ethylene glycole), poly(propylene glycole), polyurea, polyurethane, polydimethylsiloxane, polyimide, polyphenylenoxide, polyanyline, polypyrrole, polythiophene, poly(amic acid), polyacrylic acid, polyacrylonitrile, polystyrene, polybenzimidazole, polyamine, poly(ethylene imine), their sulfonated, carboxylated, PEGylated or derivatives thereof, and combinations of any of the foregoing.

In addition, the nanomembrane may specifically comprise a coating with a metal, alloy, rare earth metal, metal oxide, or combinations thereof, on at least one surface of the membrane, preferably selected from the group consisting of gold, silver, platinum, palladium, and combinations thereof.

According to a further specific aspect, the nanomembrane of the invention comprises one or more bioactive substances, preferably selected from the group comprising compounds of an enzymatic reaction, e.g. enzymes, co-factors, substrates or substrate receptors, and polysaccharides, polynucleotides, active drugs, specifically including antibiotics, antiviral agents, antimicrobial agents, anti-inflammatory agents, antiproliferative agents, cytokines, protein inhibitors, antihistamines, preferably embedded, immobilized within and/or on the surface of the membrane.

According to preferred embodiments, the bioactive substance is directly incorporated into or bound to the membrane, or indirectly immobilized, e.g. via a mediating compound or coating, e.g. by metal particles sputtered onto the membrane.

Specifically, the bioactive substance is a transporter protein, preferably a glucose or amino acid or protein transporter, or a ligand-gated ion channel.

According to the invention, there is further provided a device comprising the nanomembrane of the invention, preferably suitable for industrial, analytical, medical or diagnostic use.

Specifically, the device comprises the nanomembrane used for bioseparation, bioreaction, biotransportation and/or biodelivery purposes.

According to the invention, there is further provided a method of producing a nanomembrane of the invention, comprising the process steps

a. providing a sacrifice layer on a surface of a solid support;
b. providing a polymerized layer of less than 1000 nm thickness on the surface of the sacrifice layer, by depositing a mixture of a polymer or a polymer precursor with a pore template which is in average larger than the thickness of the polymerized layer, optionally followed by further rapid energy feed polymerization and/or crosslinking;
c. removing the pore template to obtain the polymerized layer with a controlled pore size;
d. removing the sacrifice layer, thereby separating the solid support from the polymerized layer; and
e. optionally ablating the polymerized layer, e.g. by mechanical, chemical, or thermal means.

Specifically, the polymerized layer is provided by depositing a mixture of the nanomembrane matrix, which is e.g. a liquid or semi-liquid, and the pore template onto the sacrifice layer, wherein the matrix comprises monomers, oligomers and/or a polymer, optionally followed by polymerization and/or crosslinking. Due to the chemical nature of the polymeric material, polymerization takes place at room temperature over time, but can further speed up by energy feed e.g. heat.

The mixture is preferably deposited by spin coating, roll coating or dip coating. The preferred coating process provides for coating for only one layer, i.e. to provide for a single layer, e.g. to obtain a homogenous surface.

According to a preferred embodiment, the pore template and/or the sacrifice layer is removed by dissolving in a suitable solvent or by an external stimulus, preferably by changing the temperature, pressure or voltage, e.g. by employing a vacuum. Removal of the pore template may specifically be through dissolution of the pore template, or else by evaporation, e.g. by sublimation or vaporizing. For example, the temperature may be increased and/or the pressure may be decreased to evaporate the pore template.

The polymerized layer may be subject to ablation, e.g. by mechanical, chemical, or thermal means. Therefore, the ablating process step is preferably made when the polymeric layer is still on the solid support, e.g. before or after removing the pore template, or after delaminating the polymerized layer from the support.

Specifically, the pore template may be removed while the polymerized layer is polymerizing and/or crosslinking.

According to a specific aspect of the invention, the method comprises a process step to coat a surface of the polymerized layer or at least specific sections of the surface, for example by sputtering particles of a metal, rare earth metal, metal oxide, or combinations thereof onto the polymerized layer, preferably prior to removing the solid support. Alternative methods of coating may be spin-coating, roll coating or dip-coating. The membrane may be coated before or after the removal of the pore template and pore formation.

According to a further specific aspect of the invention, the method comprises immobilizing a bioactive substance onto or within the polymerized layer, e.g. before, during or after the polymerization and/or cross-linking of the polymer and/or removal of the pore template and pore formation.

Specifically, the sacrifice layer comprises a polymer which is dissolved in the presence of a solvent or by an external stimulus, and is preferably soluble in water, ethanol or isopropanol. The sacrifice layer preferably comprises a polyelectrolyte (PSSNa), polyvinylalcohol (PVA), polyhydroxystyrene (PHS), polyacrylamide, dextrin, dextran and/or agarose.

The pore template preferably used is a compound of geometrically uncontrolled size which is either dissolved in the presence of a solvent or dispersed by an external stimulus, preferably a nanoparticle selected from the group consisting of salts, proteins, carbohydrates, inclusion bodies, bacteria, small viruses and virus-like particles, or a nanodroplet selected from the group consisting of a polyelectrolyte (PSSNa), polyvinylalcohol (PVA), polyhydroxystyrene (PHS), polyacrylamide, dextrin, dextran and agarose. The resulting pore template in the polymerized membrane is either solely defined in its characteristics through the energy intake (e.g. ultrasonic sound or mixing) during the production process, or consists of a geometrically undefined component which can be just roughly characterized in shape (e.g. inclusion bodies, viruses, bionanoparticles, bioparticles, virus like particles). Through the selection and the processing of the pore templates in combination with the other nanomembrane characteristics described in this invention, we clearly differentiate to all other comparable porous nanomembrane set ups described so far.

The resulting pore template in the polymerized membrane is either solely defined in its characteristics through the energy intake (e.g. ultrasonic sound or mixing) during the production process, or consists of a geometrically undefined component which can be just roughly characterized in shape (e.g. inclusion bodies, viruses, . . . ).

The pore template of geometrically uncontrolled size results in pores with different geometric shapes and may comprise pores with geometric shape such as for example circles, ellipse and/or with non-geometric shape. The non-geometric shape refers to shapes with irregular contours, and whose edges are not straight.

Specifically, the suitable pore templates are suspended or emulsified in the polymer precursor or polymerized material, e.g. forming a solid-liquid suspension, solid-solid inclusions in a solid or semi-solid material, liquid-liquid emulsion or liquid-solid inclusions in a solid or semi-solid material. Therefore, solid pore templates like nanoparticles, or liquid pore templates, like nanodroplets, may be used. Suitable nanodroplets would typically comprise liquids of different polarity to the polymer precursor or polymerized material.

### BRIEF DESCRIPTION OF DRAWINGS

FIG. 1: AFM image of a scratched 1% epoxide nanomembrane on a flat silicon support. With a sharp knife the membrane attached on the silicon wafer was cut and transition sections between wafer and membrane were measured. The lower half of the image displays the cross section of the indicated (white bar in the AFM image) segment, indicating a membrane thickness of 100 nm.

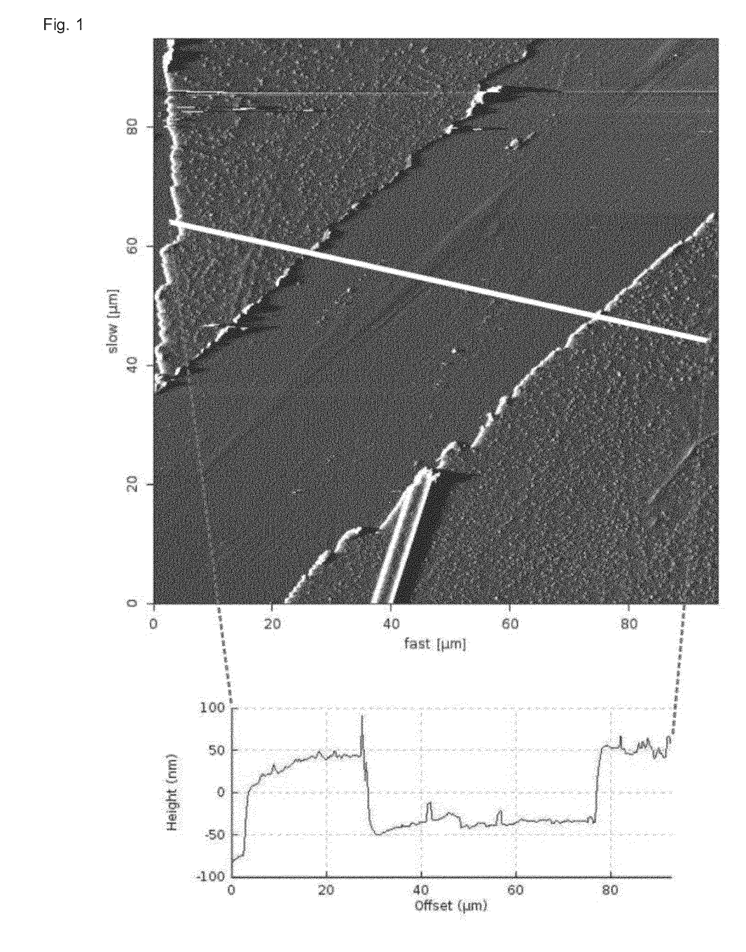

FIG. 2: AFM image of a scratched 0.1% epoxide nanomembrane on a flat silicon support. With a sharp knife the membrane on the silicon wafer was cut and transition sections between wafer and membrane were measured. The lower half of the image displays the cross section of the indicated (white bar in the AFM image) segment, indicating a membrane thickness of ˜20 nm.

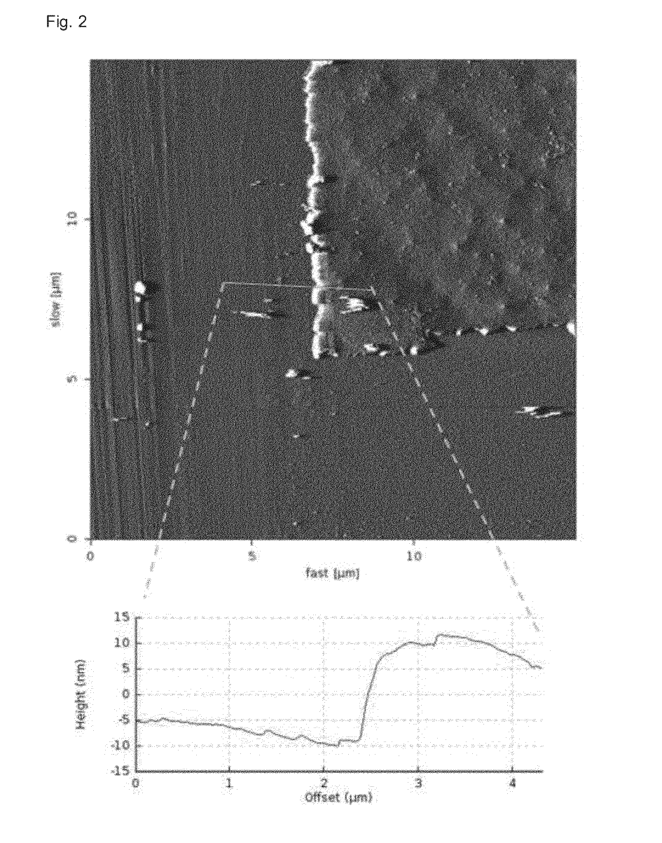

FIG. 3: Epoxide-PSSNa nanomembranes (ratio PSSNa:epoxide 1:5); dispersed by Polytron and annealed for 15 min at 50° C. (left) and ultrasonic probe, annealed for 30 min at 50° C. (right).

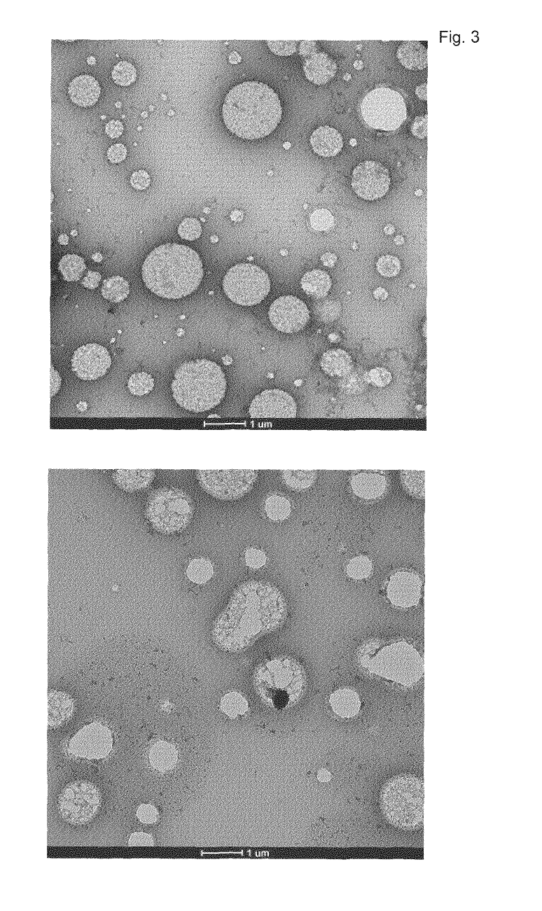

FIG. 4: Pore size distribution of a nanomembrane described in example 2. The membrane was treated for 30 s with ultrasonic probe and annealed for 30 min at 50° C. Left (A): Sample 1. Right (B): Sample 2 from the same membrane. The respective 0.05th and 0.95th quantiles are highlighted by narrow black bars.

FIG. 5: Epoxide-IB nanomembranes (1% epoxide, 10 mg/mL GFP-IBs, annealed for 5 min at 120° C.), after dissolution for 10 minutes in 50 mM HCl.

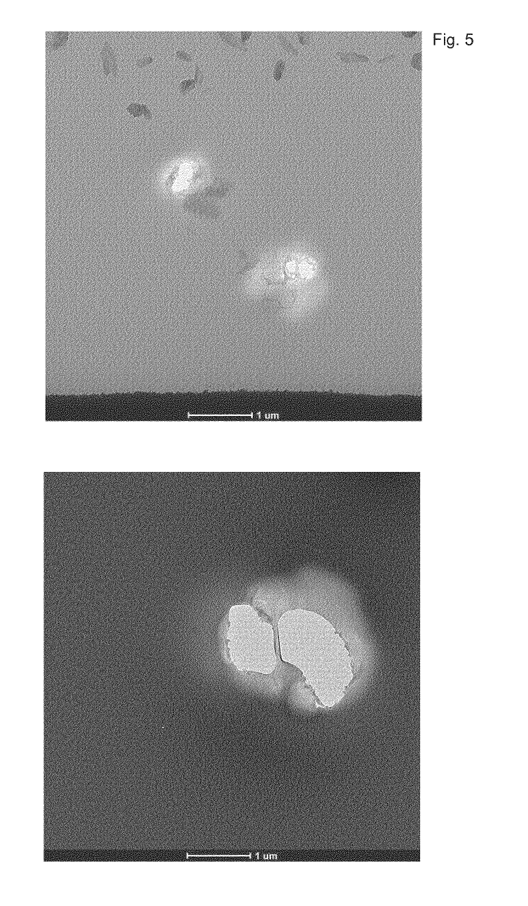

FIG. 6: The same epoxide-IB nanomembrane as shown in FIG. 5 (1% epoxide, 10 mg/mL GFP-IBs, annealed for 5 min at 120° C., after dissolution for 10 minutes in 50 mM HCl) but displaying smaller non-dissolved IBs enclosed in the epoxide matrix.

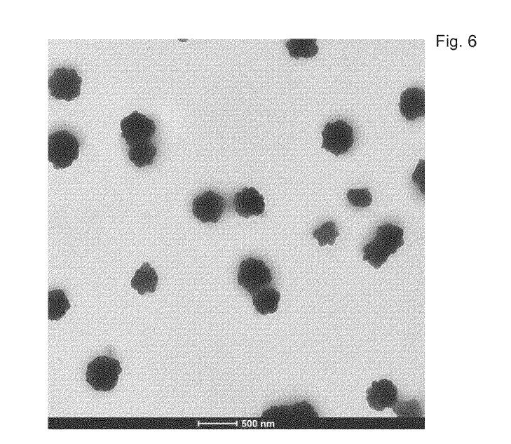

FIG. 7: TEM images of 1% epoxide nanomembrane sputtered with 1.6 nm Au and delaminated in water.

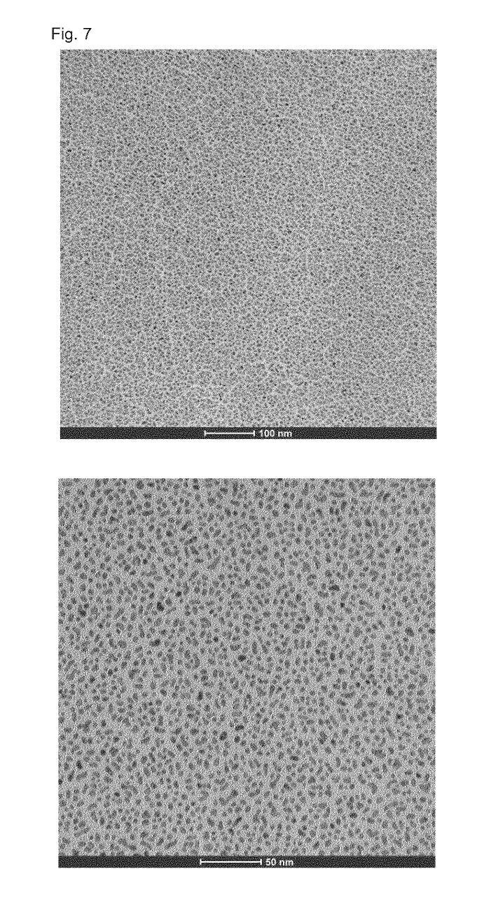

FIG. 8: TEM images of a porous 1% epoxide nanomembrane with aqueous PSSNa as pore templates, after delamination and sputtering with 1.6 nm Au.

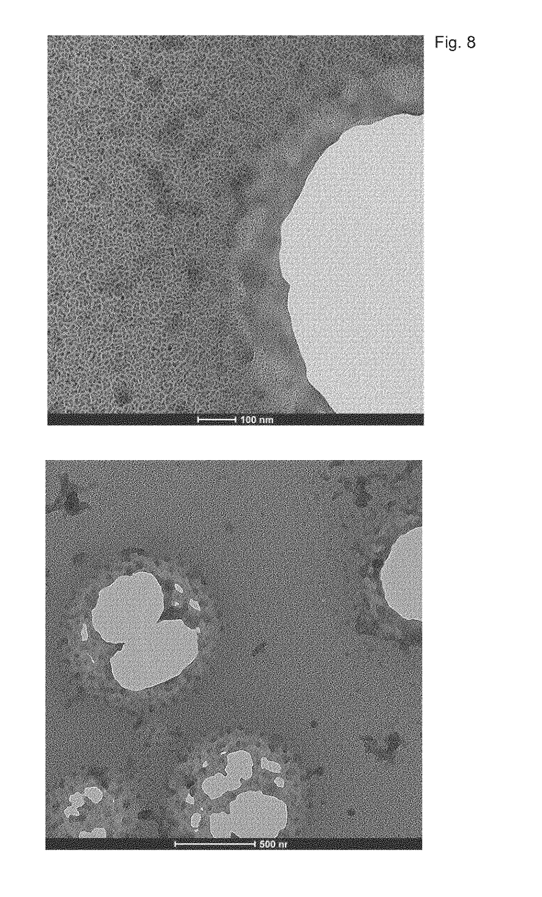

FIG. 9: Scheme for the bulging test setup.

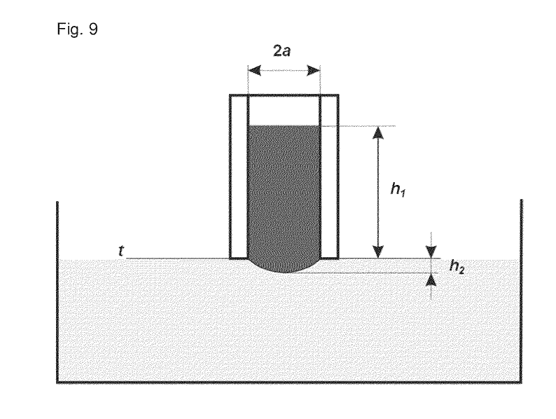

FIG. 10: Functionalized semi-porous nanomembranes with temperature controlled gold cluster formation. The epoxide matrix in all shown cases contains 70 nm deep indentations, resulting from dissolved PLGA pore templates. The membrane surface was further functionalized by gold sputtering, where the membranes in line 1 are sputtered with 3 nm, in line 2 with 6 nm and in line 3 with 10 nm gold. Rows A-D indicate the following treatments: A—untreated; B—heated for 5 minutes at 150° C.; C—heated for 15 minutes at 150° C.; D—heated for 15 minutes at 150° C. with subsequent Ar-plasma treatment.

### DESCRIPTION OF EMBODIMENTS

Specific terms as used throughout the specification have the following meaning.

The term “aspect ratio” as used herein shall mean the proportional relationship between its width and its height, e.g. the ratio of the surface dimension to the thickness of a nanomembrane, e.g. the width-to-thickness, length-to-thickness and diameter-to-thickness ratio, depending on the shape of the nanomembrane.

With regard to the nanomembrane of the invention, the term “aspect ratio” is specifically understood to refer to the ratio of the largest surface dimension like length, breadth or diameter, to the thickness of the membrane. Such membrane aspect ratio is preferably at least 10⁴, preferably at least 10⁵, or preferably ranging from 10⁴ to 10⁷, preferably from 10⁵ to 10⁶. The nanomembranes with a large aspect ratio, e.g. higher than 10⁶ or 10⁷ are specifically produced on a large scale.

With regard to the pores of the nanomembrane of the invention, the term is specifically understood as the ratio of the pore size or diameter to the thickness of the nanomembrane. Such pore aspect ratio is greater than 0.5, preferably at least 1.1, or at least 1.2, or at least 1.3, or at least 1.4, or at least 1.5, or at least 2, e.g. up to 5, typically with a tolerance of less than 50%, preferably less than 25%.

A nanomembrane with relatively low pore aspect ratio and small pores of up to 100 nm, preferably less than 50 nm may have the advantage of a high stability. The pore aspect ratio may be important for the retention or filtration time or for many classes of bioactive substances to determine the appropriate reaction time or pass-through. Typically, a relatively low pore aspect ratio, e.g. of less than 1.5, may be employed for nanomembranes comprising bioactive substances, e.g. for use as a bioreactor or support of active drugs.

Ion channel measurements are typically not affected by a high pore aspect ratio. However, carriers and transporters, including co-transporters, symporters, and antiporters, typically have lower transport rates than ion channels, resulting in low concentrations of translocated compounds in the trans-side compartment. Therefore, a relatively high pore aspect ratio, e.g. of at least 1.5 may be employed for nanomembranes comprising any such transporters.

For bioseparation purposes, a suitable pore aspect ratio would be selected depending on the viscosity of the medium and the size of the solid, liquid or gas to be separated therefrom. Typically, the pore aspect ratio employed for nanomembranes used in a bioseparation device is ranging from 0.5 to 10.

The term “bioactive” as used herein with respect to a substance is understood broadly to include any natural or synthetic material that causes a biological response in living tissue or cell. The “bioactive substance” as used in the present invention specifically includes any substance acting in live cell, and may be e.g. enzymes, or any agent involved in an enzymatic reaction, antibodies, antigens, peptides, proteins, nucleic acids, chemical drugs, and the like. Preferred selections of bioactive substances are selected from the group comprising enzymes, co-factors, substrates, substrate receptors, polysaccharides, polynucleotides, or active drugs, like antibiotics, antiviral agents, antimicrobial agents, anti-inflammatory agents, antiproliferative agents, cytokines, protein inhibitors, antihistamines, preferably immobilized within and/or on the surface of the membrane.

A specific nanomembrane according to the invention comprises a bioactive substance, which is preferably immobilized, i.e. bound to the nanomembrane, e.g. within the nanomembrane and/or on the surface of the nanomembrane or on sputtered coupling links, such as enzymes binding on gold particles. Such binding may be through affinity binding, electrostatic interactions, adhesion or covalent bonding. For example, a bioactive substance may be loaded into the pores of the nanomembrane through the openings.

The concentration of the bioactive substance mainly depends on the purpose, e.g. bioreaction, biotransportation and/or biodelivery. The effective amount of such bioactive substance may be easily determined employing knowledge and techniques well-known in the art.

The bioactive substance may be homogeneously distributed throughout the nanomembrane matrix, e.g. embedded in the matrix. According to a specific embodiment, the nanomembrane of the invention may comprise cavities resulting from imprinting a specific structure mimicking a specific bioactive substance. Thus, said specific bioactive substance may be captured within such cavities and incorporated into the nanomembrane.

The location of the bioactive substance may be e.g. within a pore and/or next to a pore or spatially distinct from a pore. In some cases, it is desirable that a bioreaction, such as an enzymatic reaction or the binding of the bioactive substance to its binding partner, e.g. a ligand-receptor binding, including antibody-antigen binding, or the hybridization of primers, polynucleotides or nucleic acids, occurs on the nanomembrane, e.g. to enable a pass-through of any substance participating in the enzymatic reaction, like a substrate or the reaction product. An active transport of compounds such as a molecule or ion through the nanomembrane may be supported by a bioactive substance that is a transporter molecule, including co-transporters and the like. Such process is herein specifically understood as biotransportation. A specific example of bioreaction and/or biotransportation is the reaction of NAD+/NADH at the nanomembrane of the invention, for the purpose of electron transportation and cellular processes involving the NAD+/NADH reaction. Electroconductive nanomembranes, such as those sputtered or coated with metal, may e.g. be used for the in situ regeneration of cofactors like NAD+/NADH.

Therefore, the bioactive substance involved in the bioreaction or biotransportation is suitably within or proximal to a pore.

In some other cases, it is desirable that a bioactive substance is delivered by the nanomembrane, e.g. by a biodelivery vehicle to provide for a controlled release and/or sustained release of the bioactive substance, or upon implanting a respective vehicle or device. The biodelivery may specifically be important for delivering the bioactive substance to an organism, including microorganisms or a higher organism, e.g. delivered to bacteria, yeast, filamentous fungi, insect cells, animals, specifically including mammals, or human beings. Therefore, the location of the bioactive substance within or on the surface of the nanomembrane is not critical. A specific example of biodelivery is the delivery of polynucleotides or nucleic acids, e.g. to obtain respective expression products, e.g. in the course of gene therapy, or the delivery of antimicrobial substances to prevent or treat microbial infections, or the delivery of binding agents to capture or neutralize receptors or other ligands.

The term “biocompatible” as used herein shall mean a material and any metabolites or degradation products thereof that are generally non-toxic to an organism or subject getting in contact or receiving such material, and do not cause any significant adverse effects to the organism or subject. The biocompatible polymer as used according to the invention may specifically be inert, and/or biodegradable, e.g. being metabolized, eliminated, or excreted by an organism or subject being contacted with such polymer.

The term “bioseparation” as used herein is intended to include the purification, separation, removal or extraction of compounds, such as inorganic or organic molecules or ions, including biological compounds, bioactive substances, reaction products, fermentation products, specifically including dissolved substances or gas, from a liquid, by capturing or binding such compounds to the nanomembrane of the present invention or passaging such compounds through the nanomembrane. Such bioseparation may be done for to purify, separate, remove or extract such compounds from the medium comprising the compound. Bioseparation process may specifically be performed in the course of ex vivo or in vivo processes, including fermentation or cultivation of organisms, analytical processes which include capture or separation of an analyte from a biological sample, or medical treatment such as extracorporeal blood purification or dialysis. Examples include the removal of waste or excess amounts of products of biological reactions in fermentation processes, including separation of products or side products of enzymatic reactions.

Devices suitable for use in the above described bioseparation, bioreaction, biotransportation and/or biodelivery purposes may specifically comprise the nanomembrane of the invention, thereby exposing the nanomembrane to provide for the contact of the nanomembrane with the surrounding. Such devices are preferably inert or biocompatible, and provided in many different forms depending on the application. Exemplary devices comprise composite membrane which comprises the nanomembrane of the invention attached to one or more further membrane(s), and/or the nanomembrane on a solid support. Specific devices are provided as disposable devices, e.g. a housing with a disposable nanomembrane.

The term “coating” as used herein with respect to a nanomembrane shall mean the process for making a tightly-adhered compound coated nanomembrane. The coating may be such as to evenly distribute the composition on one or more surfaces of the nanomembrane in one or more layers, e.g. the upper and lower surface of a planar nanomembrane, or to coat the nanomembrane on specific sections or compartments, or randomly on one or more distinct parts of the nanomembrane, thereby obtaining a diverse size of the coating or layers. The coating may have a thickness of at least 0.1 nm, preferably at least 10 nm. In some cases even thicker coatings may be used, which e.g. would have an additional support function. The coating may be homogeneously on the whole membrane surface, around the entrance of a pore and/or include also the inner pore surfaces, thereby partly or fully sealing the pores.

Specifically preferred coatings are electroconductive or conductive coatings, e.g. through the use of metal conductors. The preferred coatings are e.g. with at least one of a metal, alloy, rare earth metal, metal oxide, or combinations thereof, preferably selected from the group consisting of gold, silver, platinum, palladium, and combinations thereof.

Suitable coating techniques encompass e.g. thermal deposition or sputtering of a coating composition. Alternatively, spin-coating or dip-coating is preferably used.

Coated nanomembranes of the present invention are specifically applicable in the regeneration of cofactors or as pressure sensors, which may provide for a specific electric signal upon applying pressure onto the membrane

Further, devices comprising such coated nanomembranes may be responding to physical or chemical stimulation, e.g. pressure, heat and/or electrical stimulation, thereby e.g. opening or widening pores. Embedded substances may thus be released.

The term “controlled size” as used herein with respect to a pore template or pore size shall mean a specific mean pore size and a tolerance range, such as a standard deviation of less than 50%, preferably less than 40%, more preferred less than 30%, and/or a geometrically-defined pore size distribution of a mean pore size +/−20-50% tolerability. The nanomembrane of the invention specifically has a preferred pore size distribution that has a ratio of the pore diameter of the 95th percentile to the diameter of the 5^{th} percentile less than 10, preferably less than 5 or less than 3.

The nature of the pores is specifically controlled by controlling the size of the pore template and the conditions to remove the pore template.

The term “isolated” as used herein with respect to a nanomembrane shall mean a nanomembrane which is stable enough that it can be used as filtration device separated from any solid support. Exemplary isolated nanomembranes may be floating as fully functional free-standing or self-supporting nanomembrane, directly after the production process. Yet, according to the user required specifications, an isolated nanomembrane may be also produced as part of a composite membrane or part of a device which comprises a support and the nanomembrane, e.g. by using an isolated nanomembrane for coating the support.

The term “matrix” as used herein with respect to a porous nanomembrane shall mean the material substance of the nanomembrane that is treated to include pores or other voids or inclusions. The polymeric matrix is typically composed of one or more polymers, e.g. in a homogeneous mixture with or without bodily inclusions or pore templates. The polymeric matrix is advantageously first applied in a liquid or semi-solid form to a solid support, and then treated to solidify the matrix and/or treated to form pores.

The term “nanomembrane” as used herein shall mean thin semipermeable or permeable membranes which typically have a thickness less than 1000 nm, preferably less than 200 nm, more preferably less than 150 nm or less than 100 nm. Nanomembranes may be made from organic polymer based nanocomposites. A nanomembrane may be self-supporting or self-standing, be preformed of a defined size and shape, or flexible. It may include organic polymers, e.g. combined with inclusions, such as a pore template or nanoparticles or nanodroplets and/or pores resulting from removal of such pore template. The size of the pores allows the passage of different sized compounds.

The term “nanodroplet” as used herein shall mean a nanosized droplet, e.g. spherical droplets, comprising a liquid or semi-liquid, which typically has a nominal diameter ranging from 10 nm to 1000 nm, preferably at least 20 nm, 30 nm, 40 nm or 50 nm, up to 500 nm, preferably up to 200 nm or up to 150 nm, with a typical tolerance of +/−20%. A low tolerance range provides for a controlled size or uniformly sized mixture of nanodroplets.

The term “nanoparticle” as used herein shall mean a nanosized particular material comprising a solid or semi-solid, which typically has a nominal diameter ranging from 10 nm to 3000 nm preferably at least 20 nm, 30 nm, 40 nm, 50 nm, 500 nm, or up to 1000 nm, preferably up to 200 nm or up to 150 nm, with a typical tolerance of ±50%, ±40%, ±30%, or ±20%. A low tolerance range provides for a controlled size or uniformly sized mixture of nanoparticles.

The term “polyelectrolyte” as used herein with respect to a nanomembrane matrix is specifically understood as a polymeric electrolyte of high molecular weight that releases either positive or negative ions in water or in aqueous solution, thereby forming pores within the matrix. While a polyelectrolyte may be specifically preferred in a sacrifice layer as described herein, which is dissolvable in water or in aqueous solution, it is specifically included in the matrix of the nanomembrane of the invention only in a limited amount.

The term “polymer” as used herein is specifically understood as one or more components of the matrix of the nanomembrane of the invention. Specific examples of the polymer are organic polymers, e.g. with hydrophilic, hydrophobic or amphiphilic properties, which may or may not have a content of additives to improve the quality of the material.

Examples of the polymer include polyethylenes, polystyrenes, polycarbonates, polypropylenes, polyamides, phenol resins, epoxy resins, polycarbodiimide resins, polyvinyl chlorides, polyvinylidene fluorides, polyethylene fluorides, polyimides, acrylic resins and so forth.

Preferred examples of the polymer that can be used according to the invention include, for example, those of styrene polymers, (meth) acrylic polymers, copolymers obtained by addition polymerization of other vinyl polymers, polymers obtained by hydrogen transfer polymerization, polymers obtained by polycondensation, polymers obtained by addition condensation and so forth.

Polymers as used according to the invention may be produced by polymerizing a precursor, e.g. a monomer or oligomer, specifically through chemical reaction and/or physical treatment.

Specific examples of polymers may have an increased strength through additional cross-linking measures. For example, a crosslinking agent may be added depending on the purpose of use.

The term “pore template” as used herein shall mean a compound introduced into the matrix of a nanomembrane, e.g. into the polymer or precursor thereof, which is typically uniformly distributed or else enriched in specific areas of the nanomembrane. The pore template is then removed from the matrix, leaving a pore and a porous material, respectively. Pore templates are specifically useful to create the voids and channels in the nanomembrane of the invention.

Exemplary pore templates as used according to the invention have a size in the nanorange, e.g. in the range of 10 nm to 3000 nm to provide for the appropriate pore size, however, pore templates of less than 10 nm size may be used, e.g. when using swellable pore templates. The pore template typically has a specifically pre-defined size and shape, e.g. to provide for a controlled size of a pore which is formed upon removal of the pore template. However, the predefined size may be obtained in process. Nanodroplets may be produced in situ, e.g., upon mixing the pore template with the matrix and forming the nanodroplets under controlled conditions, such as by a specific temperature. The final size of the pore may also depend on treatment of the membrane, e.g. to widen or shrink the pore sizes.

The term “sacrifice layer” as used herein shall mean a layer positioned between a solid support and the nanomembrane of the invention, which advantageously mediates the support by the solid support during the polymer formation and/or cross-linking, and further is easily removed, thereby facilitating the delamination and separation of the nanomembrane from the solid support without destroying the nanomembrane.

The material which can be used for the sacrifice layer is not limited to a particular material as long as the material can be applied on the solid support, brought into contact with the nanomembrane or its precursor, and susceptible to removal without damaging the nanomembrane, e.g. by dissolution, evaporation or degradation, thereby separating the solid support and releasing the nanomembrane.

Preferred sacrifice layers include a polyelectrolyte (PSSNa), polyvinylalcohol (PVA), polyhydroxystyrene (PHS), polyacrylamide, dextrin, dextran and/or agarose. Solvents capable of dissolving the sacrificial layer are not particularly limited, and a solvent suitable for the purpose of use may be selected as required. One kind of these solvents alone may be used, or two or more kinds of them may be used in combination. Specific examples of suitable solvents include water, alcohols, ether alcohols, ketones, esters, aliphatic or aromatic hydrocarbons, halogenated hydrocarbons, ethers, fatty acids, organic compounds containing sulfur or nitrogen, and combinations thereof. Preferred examples include water-soluble or hydrophilic media including water, or lower alcohols such as methanol and ethanol.

The term “self-supporting” as used herein with respect to a nanomembrane shall mean a free-standing nanomembrane and specifically includes an article that is physically stable and retains its shape which may be flexible or rigid, without a support structure such as a solid support.

The term “solid support” as used herein shall mean a solid structure of defined size and shape which has physical stability and can be used in the process of producing the nanomembrane of the invention. Specific supports define the preform for the nanomembrane formation and optional sculpting. Exemplary solid supports include silicon wafer, glass slides, in general all kinds of mechanically stable, chemically resistant, e.g. resistant in chloroform, and flat materials, e.g. which possess dimensions suitable for application in spin coater devices.

The term “waterproof” as used herein with respect to a porous nanomembrane shall mean a nanomembrane that does not substantially change the kind or degree of porosity when in contact with water or an aqueous solution comprising electrolytes, or when changing the pH or salt concentration. Though a waterproof nanomembrane of the invention may change the mechanical or physical properties, the porosity is substantially unchanged. In this regard “substantially unchanged” is understood as a change of less than 20% of a pore size or porosity, e.g. less than 10%. A nanomembrane which matrix comprises a series of layers of polyelectrolytes adhered to each other, is herein not considered as “waterproof”, because the degree of porosity would substantially increase upon contact with vapor or water.

Therefore, the invention specifically provides for an isolated porous nanomembrane of the invention that has the advantage of high stability despite of the relatively large pore size.

The method specifically employs at least one solid support and at least one sacrifice layer, as a basis to deposit a polymeric matrix or a precursor thereof which is provided to obtain the polymeric nanomembrane. Through the incorporation of specific pore templates of relatively large size into the material, followed by their removal, the porous nanomembrane may be obtained. Upon removal of the sacrifice layer, the nanomembrane is delaminated and released.

It is well understood, that—depending on the selection of the materials and the conditions—some process steps may be performed consecutively or simultaneously. For example, the removal of the sacrifice layer and the pore template is preferably performed in a one-step procedure. Alternatively, the polymer formation and/or cross-linking of the polymeric matrix is performed following its deposition on the sacrificial layer, and during such polymer formation and/or cross-linking the pore template is removed.

Further preferred embodiments include the mechanical or thermal or laser ablation of the nanomembrane, e.g. if the pore templates protrude significantly from the membrane surface. Preferably, the ablation is performed before the delaminating step.

The quality control of the nanomembrane of the invention is typically performed by suitable methods.

Porosity is specifically visualized or determined by atomic force measurements or transmission electron microscopy. The sample is transferred on a support and without further treatment snapshots are taken from characteristic areas by means of tip-sample interaction (AFM) or mass-thickness contrast of the electron beam (TEM). Characteristic shapes and structures may be identified as end-to-end channels or porous structures.

The tensile strength is specifically determined by a method using hydrostatic pressure. The membrane is tested by applying a certain pressure and the resulting deformation is measured. From the deformation the maximum tensile strength is calculated.

Mechanical stability is e.g. tested by the method as exemplified below.

Any further quality controls, such as including specific physicochemical parameters, the retention time, the mass transfer, and the selectivity of a ligand, pore or other cavity, may be performed by methods well-known in the art. For example, the nanomembrane may be tested for the mass transfer rate based on diffusion or transfer, i.e. passive or active transport. A molecule of a defined size may be placed on one side of the membrane and the diffusion or transport may be measured by the concentration on the adjacent membrane side.

The nanomembrane of the invention may further comprise additives, e.g. stabilizers, including inorganic or organic compounds, preferably dissolved in the matrix of the nanomembrane or as homogeneously distributed compounds. Typical examples are dispersing agents, stabilizers, or tensides.

The subject matter of the following definitions is considered embodiments of the present invention:

An isolated polymeric waterproof nanomembrane comprising pores of different geometric shapes and of a controlled size between 10 and 1000 nm, which is larger than the thickness of the membrane.

The nanomembrane according to definition 1, which polymer is comprised in a homogeneous matrix.

The nanomembrane according to definition 2, which matrix is provided as a single layer.

The nanomembrane according to any of definitions 1 to 3, which comprises less than 80% polyelectrolytes, preferably less than 70%, more preferred less than 60%.

The nanomembrane according to any of definitions 1 to 4, wherein the pores have a through-thickness porosity.

The nanomembrane according to any of definitions 1 to 5, which has an areal porosity of 1 to 30%.

The nanomembrane according to any of definitions 1 to 6, which is self-supporting with an aspect ratio of greater than 10⁴.

The nanomembrane according to any of definitions 1 to 7, which has a tensile strength of at least 0.01 MPa, preferably at least 0.1 MPa.

The nanomembrane according to any of definitions 1 to 8, which comprises a biocompatible hydrophobic polymer, preferably of at least one monomer or oligomer selected from the group consisting of epoxides, acrylates, methacrylates, isocyanates, isothiocyanate, carbonyl chlorides, sulfonyl chlorides, amine, alcohol, phenol, anhydride, thiol, and combinations of any of the foregoing.

The nanomembrane according to any of definitions 1 to 9, which comprises a biocompatible hydrophilic polymer, preferably selected from the group consisting of polyacrylamide, polymethylmethacrylate, polyamide, polyether, polyester, polysulfone, polyethersulfones, sulfonated polyethersulfones, polyvinylalcohol, poly(ethylene glycole), poly(propylene glycole), polyurea, polyurethane, polydimethylsiloxane, polyimide, polyphenylenoxide, polyanyline, polypyrrole, polythiophene, poly(amic acid), polyacrylic acid, polyacrylonitrile, polystyrene, polybenzimidazole, polyamine, poly(ethylene imine), their sulfonated, carboxylated, PEGylated or derivatives thereof, and combinations of any of the foregoing.

The nanomembrane according to any of definitions 1 to 10, which comprises a coating with a metal, alloy, rare earth metal, metal oxide, or combinations thereof, on at least one surface of the membrane, preferably selected from the group consisting of gold, silver, platinum, palladium, and combinations thereof.

The nanomembrane according to any of definitions 1 to 11, which comprises one or more bioactive substances, preferably selected from the group comprising enzymes, co-factors, substrates, substrate receptors, polysaccharides, polynucleotides, or active drugs, like antibiotics, antiviral agents, antimicrobial agents, anti-inflammatory agents, antiproliferative agents, cytokines, protein inhibitors, antihistamines, preferably immobilized within and/or on the surface of the membrane.

The nanomembrane according to definitions 12, wherein the bioactive substance is a transporter protein, preferably a glucose or amino acid or protein transporter, or a ligand-gated ion channel.

A device comprising the nanomembrane according to any of definitions 1 to 13, preferably suitable for industrial, analytical, medical or diagnostic use.

The device according to definition 14, wherein the nanomembrane is used for bioseparation, bioreaction, biotransportation and/or biodelivery purposes.

Method of producing a nanomembrane of any of definitions 1 to 14, comprising the process steps

a. providing a sacrifice layer on a surface of a solid support;
b. providing a polymerized layer of less than 1000 nm thickness on the surface of the sacrifice layer, by depositing a mixture of a polymer or a polymer precursor with a pore template which is larger than the thickness of the polymerized layer, followed by polymerization and/or crosslinking;
c. removing the pore template to obtain the polymerized layer with a controlled pore size; and
d. removing the sacrifice layer, thereby separating the solid support from the polymerized layer.

Method according to definition 16, wherein the polymerized layer is provided by depositing a mixture of a liquid and the pore template onto the sacrifice layer, wherein the liquid comprises monomers, oligomers and/or a polymer, followed by polymerization and/or crosslinking.

Method according to definition 16 or 17, wherein the mixture is deposited by spin coating, roll coating or dip coating.

Method according to any of definitions 16 to 18, wherein the pore template and/or the sacrifice layer is removed by dissolving in a suitable solvent or by an external stimulus, preferably by changing the temperature, pressure or voltage.

Method according to any of definitions 16 to 19, wherein the pore template is removed while the polymerized layer is polymerizing and/or crosslinking.

Method according to any of definitions 16 to 20, which further comprises sputtering particles of a metal, alloy, rare earth metal, metal oxide, or combinations thereof onto the polymerized layer, preferably prior to removing the solid support.

Method according to any of definitions 16 to 21, which further comprises immobilizing a bioactive substance onto or within the polymerized layer.

Method according to any of definitions 16 to 22, wherein the sacrifice layer comprises a polymer which is dissolved in the presence of a solvent or by an external stimulus, and preferably is soluble in water, ethanol or isopropanol, which sacrifice layer preferably comprises a polyelectrolyte (PSSNa), polyvinylalcohol (PVA), polyhydroxystyrene (PHS), polyacrylamide, dextrin, dextran and/or agarose.

Method according to any of definitions 16 to 23, wherein the pore template is a compound of controlled size which is dissolved in the presence of a solvent or by an external stimulus, preferably a nanoparticle selected from the group consisting of salts, proteins, carbohydrates, inclusion bodies, bacteria, small viruses and virus-like particles, or a nanodroplet selected from the group consisting of a polyelectrolyte (PSSNa), polyvinylalcohol (PVA), polyhydroxystyrene (PHS), polyacrylamide, dextrin, dextran and agarose.

The present invention is described in further detail in the following examples, which are not in any way intended to limit the scope of the invention as claimed.

### EXAMPLES

### Example 1

### Fabrication of a Non-Porous Nanomembrane with an Aspect Ratio≧500.000

On a silicon wafer (SiMat, Kaufering, Germany) a self-standing nanomembrane was spin coated. A silicon wafer is precleaned with ethanol and water and is hydrophilized by glowing (PELCO easiGlow™ Glow Discharge Cleaning System; Ted Pella Inc., Redding, Calif., USA; 60 seconds) or plasma cleaning (Plasma Prep2; GaLa Gabler Labor Instrumente Handels GmbH, Bad Schwalbach, Germany) before spin coating of the sacrificial layer. A uniform thin film from 5% (w/w) aqueous Poly(sodium 4-styrenesulfonate) (PSSNa, M_{w} 70.000 g/mol) solution; is spin coated (Spin Coater P6700; Specialty Coating Systems Inc., Indianapolis, Ind., USA) according to the following program: Step1: ramp time of 5 sec/2000 rpm for 3 sec; Step2: ramp time of 2 sec/3000 rpm for 1 sec; Step3: ramp time of 1 sec/3000 rpm for 60 sec; final ramp time of 10 seconds. The nanomembrane is manufactured in the following way: The components of the epoxide (epoxy)-precursor solution are PEI (Polyethyleneimine, branched, average M_{w} 25.000 g/mol, Sigma) and PCGF ([Poly[(o-cresyl glycidyl ether)-co-formaldehyde]], M_{w} 870 g/mol, Sigma). They are dissolved separately in chloroform at either a concentration of 1% or 0.1% (w/w)—according to the intended thickness of the nanomembrane. To ensure a proper dissolution of both constituents, the solutions are constantly stirred in sealed glass containers at room temperature for at least 30 minutes. Mixing of both solutions at a ratio of 1:1 for at least 10 minutes results in either 1% or 0.1% epoxide precursor solutions which serves as basic polymer matrix for the respective nanomembrane. Spin coating is carried out at room temperature according to the following program: Step1: ramp time of 1 sec/2000 rpm for 1 sec; Step2: ramp time of 1 sec/4000 rpm for 1 sec; Step3: ramp time of 1 sec/8000 rpm for 60 sec; final ramp time of 10 seconds. Annealing is carried out shortly (time interval: 5-20 min.) after spin coating; the membranes are annealed for 5 minutes at 120° C. on a hot plate.

The nanomembrane is delaminated by dissolution of the sacrificial layer with water. Either before delamination from the silicon wafer or after delamination and subsequent adherence to a pre-cleaned (ethanol) flat silicon chip, topography and thickness of the nanomembranes are visualized and further examined by atomic force microscopy [AFM, JPK NanoWizard; measurements in dry contact mode with SiN₃ tips (NP-S10, Bruker); evaluation and image export via software “Data Processing” from JPK Instruments, Berlin, Germany]. For thickness measurements, the membrane on the silicon wafer was cut at various places and the transition sections between wafer and intact nanomembrane surface are examined and measured.

The aspect ratio was defined as the ratio of the characteristic length of the membrane to the thickness of a membrane (e.g.: for a disk the diameter of the disk; for a rectangular membrane the diagonal and for an irregular shaped membrane the square root of the product of the longest and shortest membrane distance).

In this particular example usage of a 1% epoxide-precursor solution yields in a 100 nm thick membrane with 5 cm in diameter. According to the definition this nanomembrane has an aspect ratio of 5×10⁵.

For using 0.1% epoxide-precursor solution, like described, a 20 nm thick membrane with 5 cm in diameter, yielding in an aspect ratio of 2.5×10⁶.

### Example 2

### Fabrication of a Porous Nanomembrane with an Aspect Ratio of 500.000 with 1% Epoxide-Precursor Solution and Aqueous PSSNa as Pore Template

The mixed 1% (w/w) epoxide-precursor solution as described in example 1 is mixed at the volume ratio PSSNa/epoxide-precursor of 1:5 with a 20% (w/w) PSSNa-water solution (M_{w} PSSNa: 1.000.000), dissolved at 50° C. under constant stirring) to obtain an emulsion by homogenization with an ultrasonic probe (Branson Sonifier 250 power module, Emerson, Danbury, Conn., USA; for 30 seconds with 50% duty cycle and output control at 6) or dispersion for 15 seconds by Polytron® (Polytron 1200 C, Kinematica, Luzern, Switzerland). The resulting turbid epoxide/aqueous-PSSNa emulsion is spin coated on the silicon wafer bearing the respective sacrificial layer as described in example 1. The membrane is annealed for 30 minutes at 50° C. and delaminated in water. In order to dissolve the PSSNa contents properly, the membrane is floating on the water surface for at least 10 minutes prior to TEM sampling.

Delaminated membranes are adhered to copper grids for direct (unstained) examination in transmission electron microscopy (TEM) (Tecnai G2 20 Twin transmission electron microscope; FEI, Eindhoven, NL).

In this particular example membrane with 5 cm diameter and a thickness of 100 nm was spin coated yielding in an aspect ratio of 5×10⁵

### Evaluation of Pore Size

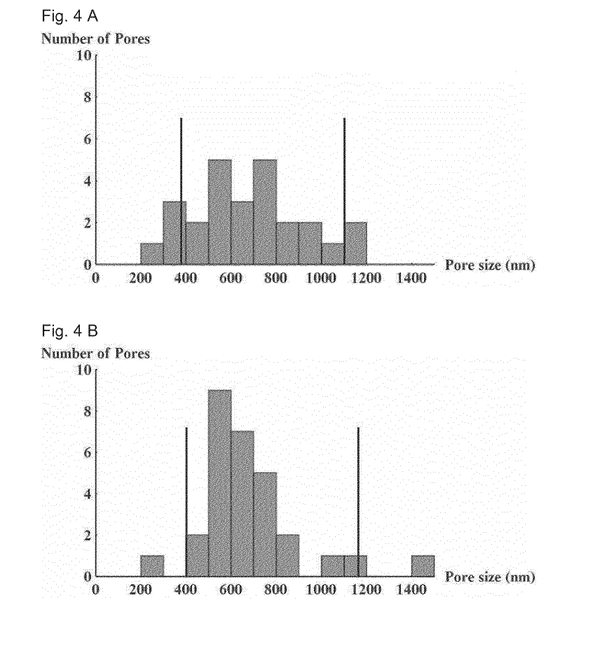

The pore size (diameter) of the nanomembrane described in example 2 was obtained from TEM and further evaluated with the software Mathematica®, where mean, standard deviation and 5% and 95% (empirical) percentiles (q_{0.05} and q_{0.95}) were calculated. Data was classified in categories of 100 nm. The pore size distributions are depicted as histograms in FIG. 4.

TABLE 1
Summary of the statistical evaluation of the pore diameter.

| (nm) | Sample 1 | Sample 2 |
|---|---|---|
| Mean | 661.3 | 675.4 |
| Standard deviation | 228.5 | 225.6 |
| 0.05^{th} quantile | 368 | 402 |
| 0.95^{th} quantile | 1100 | 1160 |

### Example 3

### Fabrication of a Porous Nanomembrane with an Aspect Ratio of 500.000 with 1% Epoxide-Precursor Solution with Inclusion Bodies as Pore Template

Inclusion bodies are prepared according to the protocol described by Marston and Hartley (Methods in Enzymology, Vol. 182, p. 264). In order to produce highly pure inclusion bodies, they are washed three times by centrifugation at 12.000 g, followed by resuspension in water and centrifugation. The clean inclusion bodies were resuspended in water and lyophilized for 48 h.

The 1% epoxide-precursor solution, as described in example 1, is mixed with 10 mg/ml lyophilized inclusion bodies (e.g.: EDDIE-GFP-IBs) in order to produce highly porous nanomembranes. The generated mixture is homogenized with ultrasonic probe (Branson Sonifier 250 power module; Branson, Danbury, Conn., USA; for 30 seconds at 50% power output and power position of 6). The resulting epoxide-IB dispersion is spin coated like described in example 1 (Spin Coater P6700; Specialty Coating Systems Inc., Indianapolis, Ind., USA) on the silicon wafer bearing the respective sacrificial layer and annealed as described in example 1. The nanomembrane is delaminated for 10 min in 50 mM HCl. Delaminated membranes are adhered to copper grids (C. Gropl, Tulln, Austria) for direct (unstained) examination in transmission electron microscopy (TEM) (Tecnai G2 20 Twin transmission electron microscope; FEI, Eindhoven, NL).

### Example 4

### Fabrication of Non-Porous and Porous Nanomembranes with an Aspect Ratio≧500,000 Sputtered with Gold

A nanomembrane as described in examples 1-3 is covered with a 1.6 nm thick layer of gold nanoparticles in a sputter coating device of Leica (Cool Sputter Coater Leica EM SCDOO5; Leica Microsystems GmbH, Vienna, Austria; thickness control by EM QSG100 Quartz Crystal Film Thickness Monitor, Leica Microsystems GmbH, Vienna, Austria). The gold covered membrane was then delaminated as described in examples 1-3. The nanomembrane was further analyzed by TEM (Tecnai G2 20 Twin transmission electron microscope; FEI, Eindhoven, NL) as described in examples 1-3.

### Example 5

### Testing of Mechanical Stability

This test method is used to measure the mechanical strength of a nanomembrane.

For this test, the freestanding membrane from example 1 is delaminated by slow immersion in water from the silicon wafer and floats on the water surface. Its edges are not fixed. A cylindrical tube consisting of poly(methylmethacrylate) (PMMA) with a height of 4 cm, an inner diameter of 9 mm and an outer diameter of 13 mm is used as reservoir for the liquid in order to stress the membrane. Both ends of this tube are open and on the upper end a thin layer of high vacuum grease (Dow Corning high vacuum grease, Wiesbaden, Germany) is applied to enhance the adhesion of the reservoir to the membrane and to enable a proper sealing.

The reservoir is held by hand on top of the floating nanomembrane and is carefully (drop by drop from a small syringe) filled with liquid. An aqueous solution stained with a dye (e.g.: food coloring substance of Dr. Oetker, Villach, Austria) is slowly pipetted into the reservoir along the wall until the maximum pressure for the nanomembrane is reached. Deflection was monitored by a digital camera (Canon). The density of the stained aqueous solution was equal to the density of water (1000 kg/m³ at room temperature).

The hydrostatic pressure P is calculated with following equation

P=ρgh₁

where ρ is the density of the liquid, g the gravitational constant and h₁ the level of the liquid placed on the membrane.

Tensile strength of the nanomembrane is estimated by the following equation:

$$σ = \frac{P}{4 t} ( {h}_{2} + \frac{{a}^{2}}{{h}_{2}} )$$

where t denotes the membrane thickness, h₂ is the maximum deflection and a is the radius of the loaded area.

For a pure epoxide membrane with a loaded area of 64 mm², the tensile strength is 2.63 MPa.

For an epoxide membrane, sputtered with a layer of 6 nm gold, with a loaded area of 64 mm², the tensile strength is 3.59 MPa.

### Example 6

### Functionalized Semi-Porous Nanomembranes with Temperature Controlled Gold Cluster Formation

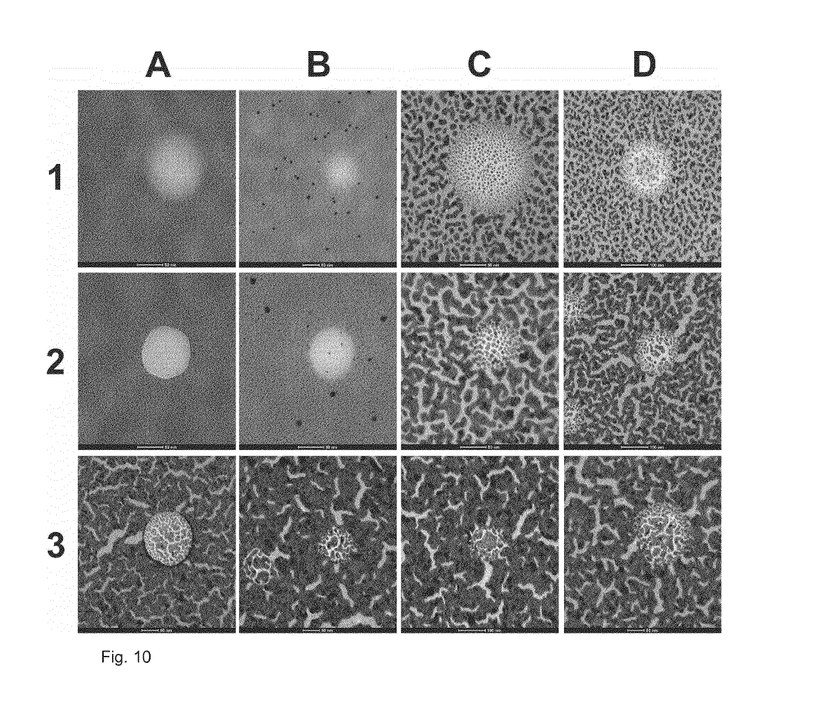

The mixed 1% (w/w) epoxide-precursor solution as described in example 1 is mixed at the volume ratio PLGA/epoxide-precursor of 1:10 with a 10 mg/ml PLGA in chloroform solution (M_{w} Poly(D,L-lactide-co-glycolide): 76.000-115.000 g/mol; ester terminated, lactide:glycolide 75:25, Sigma). The resulting epoxide/PLGA mixture is spin coated on the silicon wafer bearing the respective sacrificial layer as described in example 1. The membrane is then subjected to accelerate curing for 15 minutes at 50° C. The over-night crosslinked membrane is submerged for 60 seconds in chloroform to dissolve the PLGA pore templates, thereby forming up to 70 nm deep pores in the 100 nm thick membrane structure. These semi-porous membranes are then sputtered with the respective layer of gold molecules in a Cool Sputter Coater Leica EM SCDOO5 (Leica Microsystems GmbH, Germany) with an integrated thickness control by EM QSG100 Quartz Crystal Film Thickness Monitor (Leica Microsystems GmbH, Germany) and subsequently further treated as indicated in FIG. 10. Heat treatment of the support-membrane assembly is done on a hotplate and a Plasma Prep2 argon-operated plasma cleaner device (GaLa Gabler Labor Instrumente Handels GmbH, Germany) is optionally used for further modification. For TEM sampling the membranes are delaminated in water, immobilized and dried on copper grids for direct (unstained) examination in transmission electron microscopy (TEM) (Tecnai G2 20 Twin transmission electron microscope; FEI, Eindhoven, NL).

1. An isolated polymeric waterproof nanomembrane comprising pores of different geometric shapes and of controlled size between 10 and 1000 nm, wherein the pores are larger than the thickness of the membrane.

2. The nanomembrane of claim 1, wherein the nanomembrane has an areal porosity of 1 to 30%.

3. The nanomembrane of claim 1, wherein the nanomembrane is self-supporting with an aspect ratio of greater than 104.

4. The nanomembrane of claim 1, wherein the nanomembrane has a tensile strength of at least 0.01 MPa, preferably at least 0.1 MPa.

5. The nanomembrane of claim 1, wherein the nanomembrane comprises:
a. a biocompatible hydrophobic polymer comprising at least one monomer or oligomer selected from the group consisting of an epoxide, an acrylate, a methacrylate, an isocyanate, an isothiocyanate, a carbonyl chloride, a sulfonyl chloride, an amine, an alcohol, a phenol, an anhydride, a thiol, and combinations of any of the foregoing; and/or
b. a biocompatible hydrophilic polymer selected from the group consisting of a polyacrylamide, a polymethylmethacrylate, a polyamide, a polyether, a polyester, a polysulfone, a polyethersulfones, a sulfonated polyethersulfone, a polyvinylalcohol, a poly(ethylene glycole), a poly(propylene glycole), a polyurea, a polyurethane, a polydimethylsiloxane, a polyimide, a polyphenylenoxide, a polyanyline, a polypyrrole, a polythiophene, a poly(amic acid), a polyacrylic acid, a polyacrylonitrile, a polystyrene, a polybenzimidazole, a polyamine, a poly(ethylene imine), their sulfonated, carboxylated, PEGylated or derivatives thereof, and combinations of any of the foregoing.

6. The nanomembrane of claim 1, wherein the nanomembrane comprises a coating on at least one surface of the membrane, wherein the coating comprises a material selected from the group consisting of a metal, an alloy, a rare earth element, a metal oxide, and combinations thereof.

7. The nanomembrane of claim 1, wherein the nanomembrane comprises one or more bioactive substances selected from the group consisting of enzymes, co-factors, enzyme substrates, substrate receptors, polysaccharides, polynucleotides, transporter proteins, ligand-gated ion channels, and active drugs.

8. A device comprising the nanomembrane of claim 1, wherein the device is suitable for industrial use, analytical use, medical use diagnostic use, bioseparation, bioreaction, biotransportation and/or biodelivery purposes.

9. A method of producing the nanomembrane of claim 1, comprising the following process steps:
a. providing a sacrifice layer on a surface of a solid support;
b. providing a polymerized layer having a thickness of less than 1000 nm on the surface of the sacrifice layer by depositing a mixture of a polymer or a polymer precursor with a geometrically undefined pore template, wherein pores of the pore template are larger than the thickness of the polymerized layer, followed by polymerization and/or accelerated energy driven crosslinking;
c. removing the pore template to obtain the polymerized layer with a controlled pore size; and
d. removing the sacrifice layer, thereby separating the solid support from the polymerized layer.

10. The method of claim 9, wherein the polymerized layer is provided by depositing a mixture of a liquid and the pore template onto the sacrifice layer, wherein the liquid comprises monomers, oligomers and/or a polymer, followed by polymerization and/or crosslinking.

11. The method of claim 9, wherein the pore template and/or the sacrifice layer is removed by dissolving the pore template and/or the sacrifice layer in a suitable solvent or by changing the temperature, pressure or voltage of the nanomembrane.

12. The method of claim 9, further comprising the step of sputtering particles of a metal, alloy, rare earth metal, metal oxide, or combinations thereof onto the polymerized layer, preferably prior to removing the solid support.

13. The method of claim 9, further comprising the step of immobilizing a bioactive substance onto or within the polymerized layer.

14. The method of claim 9, wherein the sacrifice layer comprises a polymer which is dissolved in the presence of a solvent selected from the group consisting of water, ethanol and isopropanol, and wherein the sacrifice layer comprises a polyelectrolyte (PSSNa), a polyvinylalcohol (PVA), a polyhydroxystyrene (PHS), a polyacrylamide, dextrin, dextran and/or agarose.

15. The method of claim 9, wherein the geometrically undefined pore template is a compound of controlled size which is either a nanoparticle selected from the group consisting of salts, proteins, carbohydrates, inclusion bodies, bacteria, small viruses and virus-like particles, bionanoparticles, bioparticles, or a nanodroplet selected from the group consisting of a polyelectrolyte (PSSNa), a polyvinylalcohol (PVA), a polyhydroxystyrene (PHS), a polyacrylamide, dextrin, dextran and agarose.

16. The nanomembrane of claim 6, wherein the metal is selected from the group consisting of gold, silver, platinum, palladium, and combinations thereof.

17. The nanomembrane of claim 7, wherein the transporter protein is a glucose transporter protein or an amino acid transporter protein.

18. The nanomembrane of claim 7, wherein the active drug is selected from the group consisting of an antibiotic, an antiviral agent, an antimicrobial agent, an anti-inflammatory agent, an antiproliferative agent, a cytokines, a protein inhibitor, and an antihistamine.

19. The method of claim 10, wherein the polymerized layer is provided by spin coating, roll coating or dip coating.

20. The method of claim 11, wherein the pore template is removed while the pre-polymerized layer is further polymerizing and/or crosslinking.
